(19) United States
(12) Patent Application Publication
(10) Pub. No.: US 2017/0288956 A1
(43) Pub. Date: Oct. 5, 2017

(54) NODE CONFIGURATION ASSIGNMENT USING A MOBILE COMMUNICATION DEVICE

(71) Applicant: Lenovo Enterprise Solutions (Singapore) Pte. Ltd., Singapore (SG)

(72) Inventors: David D. Chudy, Raleigh, NC (US); James G. McLean, Raleigh, NC (US); Dharmesh Narendra Topiwala, Apex, NC (US)

(21) Appl. No.: 15/084,061

(22) Filed: Mar. 29, 2016

(51) Int. Cl. H04L 12/24; H04L 29/12; H04W 4/00

(52) U.S. Cl. CPC H04L 41/0803; H04L 41/12; H04W 4/008; H04L 41/22; H04L 61/2007; H04W 84/12

(57) ABSTRACT

A mobile communication device is used to assign a configuration to a designated compute node by wirelessly transmitting a configuration identifier to the designated compute node. The designated compute node receives the configuration identifier and provides the configuration identifier to a management node accessible over a network in order to receive configuration data associated with the configuration identifier. The designated compute node receives the configuration data and applies the configuration data to achieve the assigned configuration. This method may be used to configure a plurality of compute nodes, although each of the compute nodes may assigned the same or different configuration.

### BACKGROUND

### Field of the Invention

The present invention relates to configuring a compute node for use in a network including multiple compute nodes.

### Background of the Related Art

The initial deployment and setup of a large computing system can be a complex and time consuming process. The physical arrangement and connections within a datacenter must be meticulously accurate to assure proper and reliable operation of the system. Furthermore, hardware components such as compute nodes may perform different roles within the system as a whole, such that the software or firmware configurations may differ from one component to another.

Various methods to facilitate the configuration of a large computing system generally require the system components to be powered on and connected to a network. Accordingly, a management node may execute a management tool to implement a predetermined configuration on each of the system components. A considerable amount of skill and effort are required to put a large computing system into a condition wherein such a configuration process can occur.

### BRIEF SUMMARY

One embodiment of the present invention provides a method for configuring a compute node. The method comprises a mobile communication device assigning a configuration to a designated compute node by wirelessly transmitting a configuration identifier to the designated compute node. The designated compute node receives the configuration identifier from the mobile communication device and provides the configuration identifier to a management node accessible over a network. The management node may then use the configuration identifier to identify configuration data uniquely associated with the configuration identifier, and send the identified configuration data to the designated compute node over the network. The designated compute node receives the configuration data from the management node and applies the configuration data to achieve the assigned configuration.

Another embodiment of the present invention provides a method for configuring a plurality of compute nodes, such as configuring a plurality of compute nodes within a network including a management node. The method may include the same steps for each of the plurality of compute nodes, although each of the compute nodes may receive the same or different configuration identifier. Accordingly, the method described here may include any of the steps or embodiments described herein for configuring a single compute node. For example, the method may include, for each of the plurality of compute nodes in the network including a management node, a mobile communication device assigning a configuration to a designated compute node by wirelessly transmitting a configuration identifier to the designated compute node. The designated compute node receives the configuration identifier from the mobile communication device and provides the configuration identifier to a management node accessible over a network. The management node may then use the configuration identifier to identify configuration data uniquely associated with the configuration identifier, and send the identified configuration data to the designated compute node over the network. The designated compute node receives the configuration data from the management node and applies the configuration data to achieve the assigned configuration.

Yet another embodiment of the present invention provides a computer program product comprising a non-transitory computer readable storage medium having program instructions embodied therewith, wherein the program instructions are executable by a processor to cause the processor to perform a method. One such method comprises a mobile communication device assigning a configuration to a designated compute node by wirelessly transmitting a configuration identifier to the designated compute node. The designated compute node receives the configuration identifier from the mobile communication device and provides the configuration identifier to a management node accessible over a network. The management node may then use the configuration identifier to identify configuration data uniquely associated with the configuration identifier, and send the identified configuration data to the designated compute node over the network. The designated compute node receives the configuration data from the management node and applies the configuration data to achieve the assigned configuration.

### BRIEF DESCRIPTION OF THE SEVERAL VIEWS OF THE DRAWINGS

FIG. 1 is a system diagram of a mobile communication device in communication with a compute node in a network including a plurality of compute nodes and a management node.

FIG. 2 is a diagram of a mobile communication device that may be used to provide a configuration identifier to a designated compute node.

FIG. 3 is a diagram of a compute node that may be included in the network as either one of the plurality of compute nodes or as the management node.

FIG. 4 is an illustration of a display screen of a mobile communication device displaying a graphical user interface for providing a configuration identifier to a designated compute node.

FIG. 5 is a flowchart of a method according to one embodiment of the present invention.

### DETAILED DESCRIPTION

One embodiment of the present invention provides a method for configuring a compute node. The method comprises a mobile communication device assigning a configuration to a designated compute node by wirelessly transmitting a configuration identifier to the designated compute node. The designated compute node receives the configuration identifier from the mobile communication device and provides the configuration identifier to a management node accessible over a network. The management node may then use the configuration identifier to identify configuration data uniquely associated with the configuration identifier, and send the identified configuration data to the designated compute node over the network. The designated compute node receives the configuration data from the management node and applies the configuration data to achieve the assigned configuration.

A compute node may be configured in various ways, and the configuration data may include data for configuring any one or more aspects of a compute node. For example, the configurable aspects may include, without limitation, settings for the system BIOS, settings for the system management controller (BMC), settings for local storage devices, settings for I/O adapters, and system boot order. These settings control many aspects of system operation including port assignments, error handling options, Dynamic Domain Name Service (DINS) options, thermal and power behavior settings, security settings, mode settings for memory, CPU, and other hardware components, error handling and reporting settings, bus speed selections, and adapter addressing and operating modes.

It should be appreciated that although the mobile communication device provides a configuration identifier and any node-specific customization, the mobile communication device does not provide the actual configuration data that the compute node requires to apply the configuration. While the configuration identifier may further identify the location of the configuration data uniquely associated with the configuration identifier, this information is inaccessible to an outside entity that does not have the necessary network connection and network authentication. This makes the system robust against hacking or accidental corruption. Furthermore, the method makes it possible to configure a large number of compute nodes in a very short period of time.

The configuration identifier may, for example, be any alphanumeric or binary code. However, the configuration identifier should be uniquely associated with configuration data, and both the configuration identifier and the associated configuration data may be stored together in a configuration record that is accessible to the management node in a central database that includes a plurality of configuration records. The plurality of configuration records may include at least one configuration record for each type or role of compute node desired within the network.

The configuration identifier is wirelessly transmitted from the mobile communication device to a designated compute node using any wireless technology or protocol. For example, the wireless transmission may use a communication protocol selected from near-field communication (NFC), wireless local area network (such as Wi-Fi™) and mobile personal area network (such as Bluetooth™). Accordingly, both the mobile communication device and the plurality of compute nodes need to have the appropriate hardware in order to implement the wireless transmissions, such as a NEC transceiver, Wi-Fi™ transceiver or Bluetooth™ transceiver.

In one embodiment, the mobile communication device transmits the configuration identifier to the designated compute node using near-field communication (NFC), such that the mobile communication device and the designated compute node may be paired for wireless communication in response to a physical tap between the mobile communication device and the designated compute node. In such an embodiment, the physical tap serves to identify the designated compute node that should be enabled to receive the configuration identifier. Advantageously, a group of compute nodes that are intended to be have the same configuration may be provided with the same configuration identifier by setting the mobile communication device to transmit the configuration identifier and sequentially tapping each of the compute nodes in the group.

The designated compute node may receive the configuration identifier prior to boot up of the designated compute node or even prior to the designated compute node being connected to the network. For example, the designated compute node may receive the configuration identifier while connected to a power source without being powered on. In certain embodiments, the designated compute node may include a service processor that receives the configuration identifier. A service processor, such as a baseboard management controller or an integrated management module, will typically receive power even when the compute node is powered off and is, therefore, able to receive the configuration identifier. Furthermore, in one embodiment, the service processor may request configuration data associated with the configuration identifier over an out-of-band communication channel.

The mobile communication device may run a program or application (“app”) that allows a user to manually select a configuration, and therefore also selecting the configuration identifier, via a graphical user interface. The manually selected configuration identifier may then be transmitted to a designated compute node as described above. The graphical user interface may facilitate the selection by displaying various selectable configurations, perhaps in a list or menu format, or providing an entry box. Alternatively, the app may have access to a list of the compute node configurations that are needed in the network being implemented and sequentially request the user tap the mobile communication device against a compute node that should be configured in the displayed manner.

The graphic user interface may also be used to input customized configuration details prior to transmitting the configuration identifier to the designated compute node, such that the customized configuration details are wirelessly transmitted to the designated compute node along with the configuration identifier. For example, the customized configuration details may include a virtual network interface card address.

Since the mobile communication device does not transmit all of the configuration data, it is necessary for the compute node to connect with the management node in order to request receive the configuration data associated with the configuration identifier. This connection may be established before or after the compute node receives the configuration identifier. in one option, the method further comprises the designated compute node presenting node identity or authentication information to the management node, wherein the management node sends the identified configuration data to the designated compute node in response to verifying that the designated compute node is authorized to receive the configuration data. Accordingly, the configuration data is only provided if the compute node is successfully authenticated to the management node.

Another embodiment of the present invention provides a method for configuring a plurality of compute nodes, such as configuring a plurality of compute nodes within a network including a management node. The method may include the same steps for each of the plurality of compute nodes, although each of the compute nodes may receive the same or different configuration identifier. Accordingly, the method described here may include any of the steps or embodiments described herein for configuring a single compute node. For example, the method may include, for each of the plurality of compute nodes in the network including a management node, a mobile communication device assigning a configuration to a designated compute node by wirelessly transmitting a configuration identifier to the designated compute node. The designated compute node receives the configuration identifier from the mobile communication device and provides the configuration identifier to a management node accessible over a network. The management node may then use the configuration identifier to identify configuration data uniquely associated with the configuration identifier, and send the identified configuration data to the designated compute node over the network. The designated compute node receives the configuration data from the management node and applies the configuration data to achieve the assigned configuration.

In one option, the mobile communication device may automatically increment one or more parameter of the configuration after assigning a configuration to each compute node, wherein the mobile communication device sequentially assigns a configuration to each compute node. For example, each configuration may include a custom Internet protocol address that is generated by the mobile communication device. To generate the addresses, the method may define a starting Internet protocol address for a first configuration, and then automatically increment the Internet protocol address included in each successive configuration that is assigned to a compute node.

In a further option, the mobile communication device may store a list of compute nodes that have been assigned a configuration, wherein the list identifies each compute node and the configuration that was assigned to each compute node. Such a list may be used by the mobile communication device to verify, prior to transmitting a configuration identifier to a compute node, that the designated compute node has not already been given a configuration identifier. Furthermore, the mobile communication device may provide the list to the management node. The management node may confirm that the desired types and number of compute node configurations are being initiated, perhaps by comparing the provided list against a master list of compute nodes desired for the network. Furthermore, the management node may receive lists of configurations assigned by multiple mobile communication devices, such that the management node may verify that the mobile communication devices are assigning configurations consistent with a master list of compute node types and numbers. For example, the management node may server to prevent duplicate configurations or conflicts in customized configuration parameters.

Yet another embodiment of the present invention provides a computer program product comprising a non-transitory computer readable storage medium having program instructions embodied therewith, wherein the program instructions are executable by a processor to cause the processor to perform a method. One such method comprises a mobile communication device assigning a configuration to a designated compute node by wirelessly transmitting a configuration identifier to the designated compute node. The designated compute node receives the configuration identifier from the mobile communication device and provides the configuration identifier to a management node accessible over a network. The management node may then use the configuration identifier to identify configuration data uniquely associated with the configuration identifier, and send the identified configuration data to the designated compute node over the network. The designated compute node receives the configuration data from the management node and applies the configuration data to achieve the assigned configuration.

However, embodiments of the present invention may include computer program products including program instructions for implementing or initiating any one or more aspects of any of the methods described herein. Accordingly, a separate description of the methods will not be duplicated in the context of a computer program product.

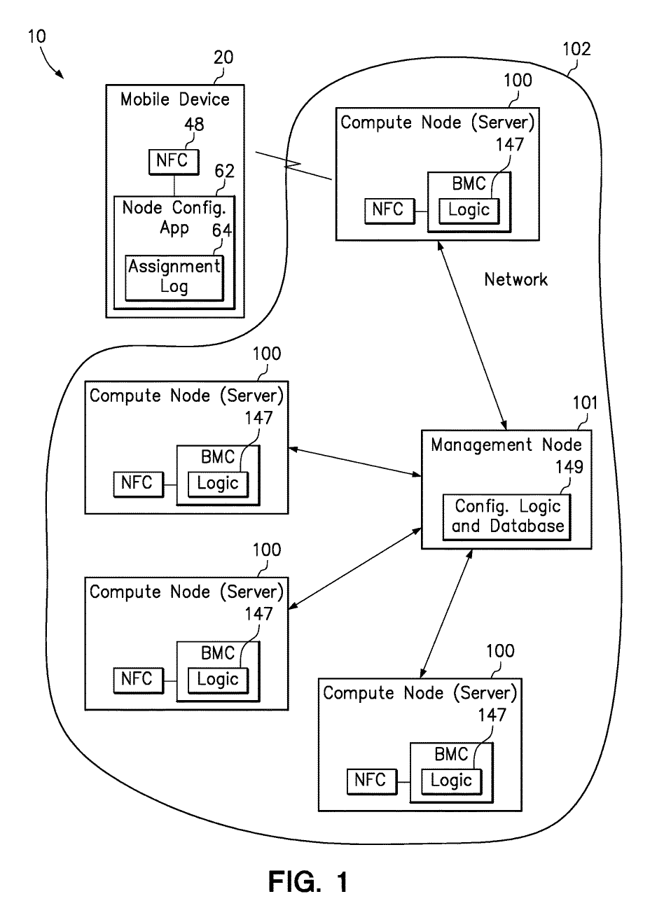

FIG. 1 is a diagram of a system 10 including a mobile communication device 20 in communication with a designated compute node 100 in a network 102 having a plurality of compute nodes 100 and a management node 101. The mobile communication device 20 includes a node configuration app 62 including an assignment log 64 for keeping track of the configurations that have been assigned to the compute nodes 100. The mobile communication device 20 also includes a near-field communication device 48 or transceiver that can transmit and receive communications to and from a compute node 100. Preferably, the mobile communication device 20 will communicate with only one compute node 100 at a time in order to send a configuration identifier intended for the specifically designated compute node. For example, the mobile communication device 20 may use a near-field communication protocol to pair with a designated compute node 100, perhaps using physical tap of the mobile communication device against the designated compute node. Accordingly, the mobile communication may transmit a configuration identifier to the designated (paired) compute node, and preferably also receive a confirmation or identity of the compute node for inclusion in the assignment log 64 along with the configuration or configuration identifier that was assigned to the designated compute node.

For setting up the network 102, the mobile communication device 20 may repeat the foregoing process in order to sequentially assign a configuration to each of the compute nodes 100 in the network. The compute nodes 100 may receive the same or different configurations according to the use of the node configuration app 62. The management node 101 includes configuration logic and database 149, which includes configuration data files uniquely associated with configuration identifiers. In response to receiving a request and configuration identifier from a compute node, the management node 101 will provide the requesting compute node with the configuration data file associated with the configuration identifier. The configuration data provided by the management node 101 enables the compute node to achieve the configuration assigned to the compute node by the mobile communication device 20.

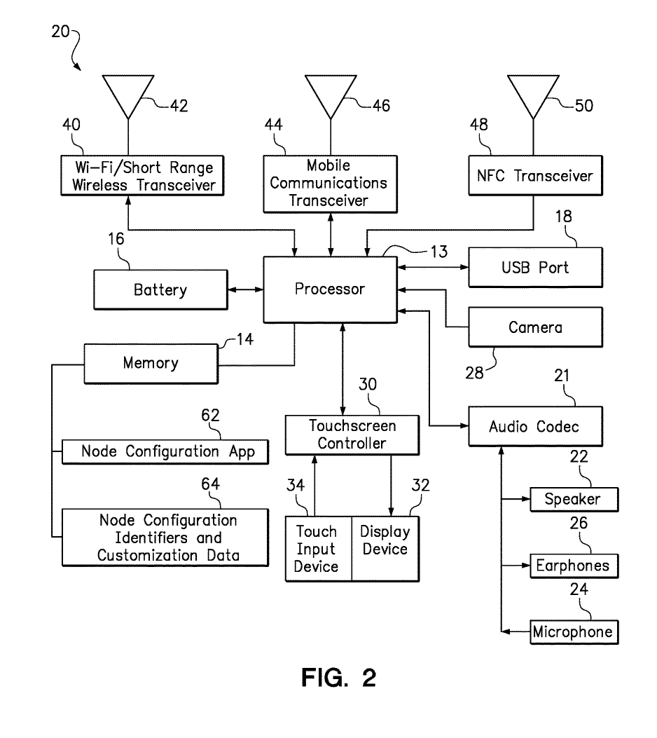

FIG. 2 is a diagram of the mobile communication device 20, such as a smart phone or tablet computer, that may be used to provide a configuration identifier to a designated compute node according to various embodiments of the present invention. The computing device 20 may include a processor 13, memory 14, a battery 16, a universal serial bus (USB) port 18, a camera 28, and an audio codec 21 coupled to a speaker 22, a microphone 24, and an earphone jack 26. The communication device 10 may further include a touchscreen controller 30 which provides a graphical output to the display device 32 and an input from a touch input device 34. Collectively, the display device 32 and touch input device 34 may be referred to as a touchscreen.

The computing device 20 may also include a Wi-Fi™ and/or Bluetooth™ transceiver 40 and corresponding antenna 42, a mobile communication transceiver 44 and corresponding antenna 46, and/or a near-field communication (NFC) transceiver 48 and corresponding antenna 50. Accordingly, one of the transceivers enables communication between the mobile communication device 20 and a designated compute node. In order to implement one or more embodiment of the present invention, the memory 14 may store a node configuration application 62 and node configuration data 64. For example, the node configuration application 62 may generate a graphical user interface that allows a user to select a configuration to be assigned to a compute node, optionally customize that configuration, and then transmit a configuration identifier and optional customization data to the compute node. The node configuration data 64 may include historical records of assigned configurations, where each record may identify a compute node and the configuration assigned to that compute node.

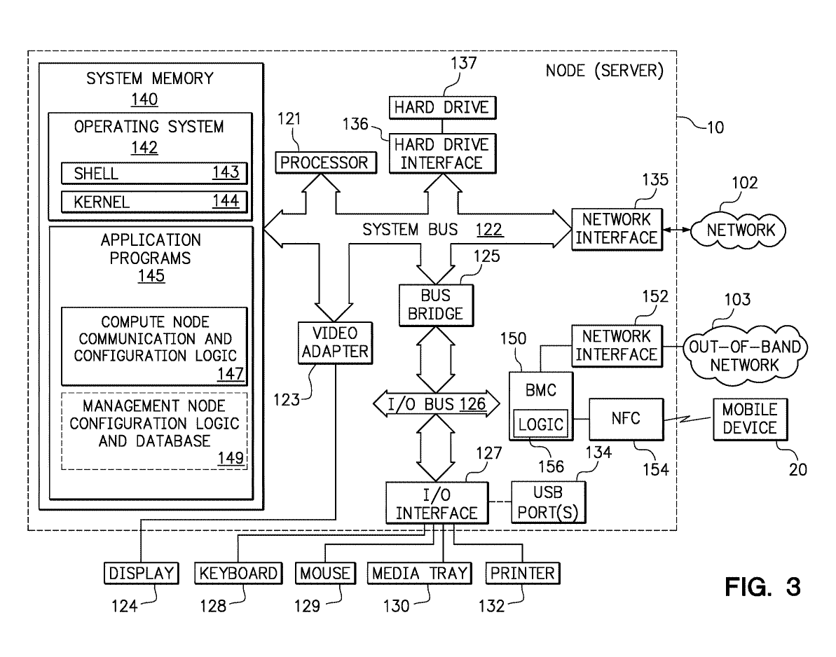

FIG. 3 is a diagram of a compute node or server 100 that may be included in the network as either one of the plurality of compute nodes 100 or as the management node 101 of FIG. 1, and is capable of use in accordance with methods of the present invention. In this non-limiting example, the compute node 100 includes a processor unit 121 that is coupled to a system bus 122. The processor unit 121 may utilize one or more processors, each of which has one or more processor cores. A video adapter 123, which drives/supports a display 124, may also be coupled to the system bus 122. The system bus 122 may also be coupled via a bus bridge 125 to an input/output (I/O) bus 126. Furthermore, an I/O interface 127 may be coupled to the I/O bus 126 to provide communication with various I/O devices, optionally including a keyboard 128, a mouse 129, a media tray 130 (which may include storage devices such as CD-ROM drives, multi-media interfaces, etc.), a printer 132, and/or USB port(s) 134. As shown, the compute node 100 is able to communicate with other network devices, such as the management node 101 (see FIG. 1), via the network 102 using a network adapter or network interface controller 135.

A hard drive interface 136 is also coupled to the system bus 122. The hard drive interface 136 interfaces with a hard drive 137. In a preferred embodiment, the hard drive 137 communicates with system memory 140, which is also coupled to the system bus 122. System memory includes the lowest level of volatile memory in the compute node 120. This volatile memory may include additional higher levels of volatile memory (not shown), including, but not limited to, cache memory, registers and buffers. Data that populates the system memory 140 includes the operating system (OS) 142 and application programs 145.

The operating system 142 includes a shell 143 for providing transparent user access to resources such as application programs 145. Generally, the shell 143 is a program that provides an interpreter and an interface between the user and the operating system. More specifically, the shell 143 executes commands that are entered into a command line user interface or from a file. Thus, the shell 143, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 144) for processing. Note that while the shell 143 is a text-based, line-oriented user interface, the present invention will equally well support other user interface modes, such as graphical, voice, gestural, etc. As depicted, the operating system 142 also includes the kernel 144, which includes lower levels of functionality for the operating system 142, including providing essential services required by other parts of the operating system 142 and application programs 145, including memory management, process and task management, disk management, and mouse and keyboard management.

The compute node 100 further includes a baseboard management module (BMC) 150 having its own network interface 152 or an integrated management module that combines the functions of the BMC and network interface into a single entity. However, the network interface 152 may enable the BMC 150 to communicate over an out-of-band network or other connection 103 to request and receive configuration data from the management node even if the compute node is powered off. Furthermore, the BMC 150 is coupled to a near-field communication (NFC) device 154 capable of communication with the mobile communication device 20. The BMC 150 executes logic 156 that may, in various embodiments, include the compute node communication and configuration logic 147 or the management node configuration logic and database 149.

The hardware elements depicted in the compute node 100 are not intended to be exhaustive, but rather are representative. For instance, the compute node 100 may include alternate memory storage devices such as magnetic cassettes, digital versatile disks (DVDs), Bernoulli cartridges, and the like. These and other variations are intended to be within the scope of the present invention.

The application programs 145 in the system memory of the compute node 100 may include, without limitation, compute node communication and configuration logic 147 in accordance with various embodiments of the present invention. Where the compute node 100 is implemented as the management node 101 (See FIG. 1), the application programs 145 may instead include management node configuration logic and database 149 in accordance with various embodiments of the present invention. It should be appreciated that certain embodiments of the present invention involve multiple entities executing separate logic in a coordinated manner. For example, embodiments may include the node configuration app 62 performing aspects of the invention on the mobile communication device 20 (FIG. 2), the compute node communication and configuration logic 147 performing aspects of the invention on the individual compute nodes 100, and the management node configuration logic and database 149 performing aspects of the invention on the management node 101.

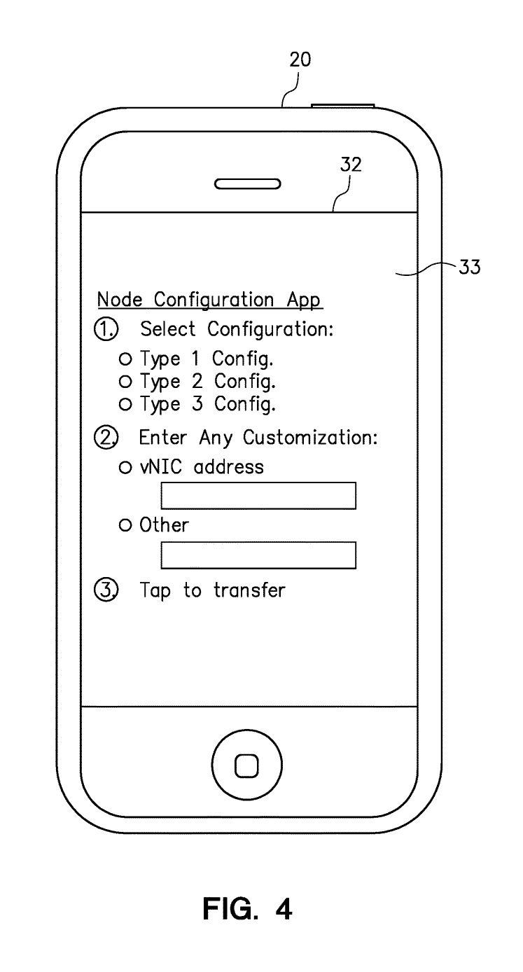

FIG. 4 is an illustration of a display screen 32 of a mobile communication device 20 displaying a graphical user interface 33 for providing a configuration identifier to a designated compute node. In this non-limiting example, the interface 33 allows a user to select a configuration from a predetermined list of configuration types, enter any customization of the selected configuration, and then initiate a tap to transfer the resulting configuration identifier and customization data to the compute node.

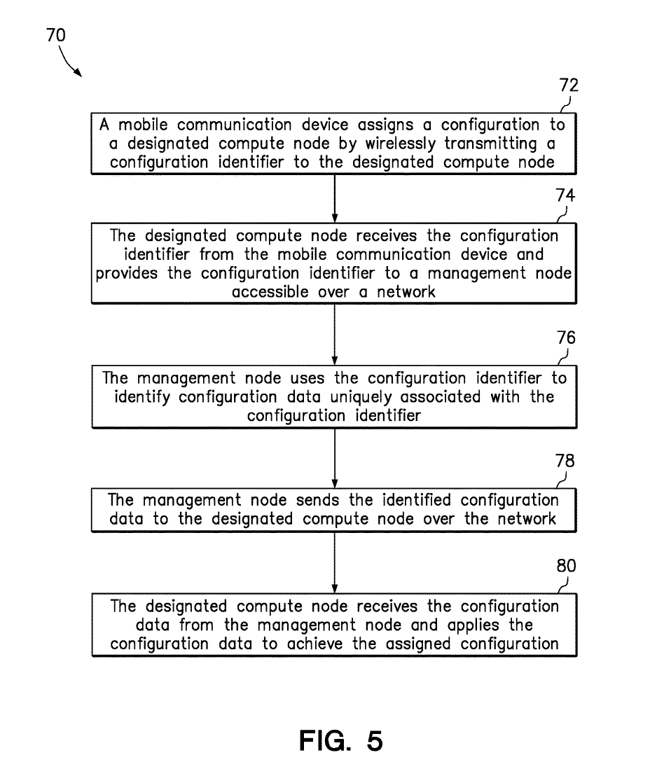

FIG. 5 is a flowchart of a method 70 according to one embodiment of the present invention. In step 72, a mobile communication device assigns a configuration to a designated compute node by wirelessly transmitting a configuration identifier to the designated compute node. In step 74, the designated compute node receives the configuration identifier from the mobile communication device and providing the configuration identifier to a management node accessible over a network. The management node then uses the configuration identifier to identify configuration data uniquely associated with the configuration identifier in step 76, and sends the identified configuration data to the designated compute node over the network in step 78. Then, in step 80, the designated compute node receives the configuration data from the management node and applies the configuration data to achieve the assigned configuration.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a mobile communication device assigning a configuration to a designated compute node by wirelessly transmitting a configuration identifier to the designated compute node;
the designated compute node receiving the configuration identifier from the mobile communication device and providing the configuration identifier to a management node accessible over a network;
the management node using the configuration identifier to identify configuration data uniquely associated with the configuration identifier;
the management node sending the identified configuration data to the designated compute node over the network; and
the designated compute node receiving the configuration data from the management node and applying the configuration data to achieve the assigned configuration.

2. The method of claim 1, further comprising:
the designated compute node presenting node identity or authentication information to the management node, wherein the management node sends the identified configuration data to the designated compute node in response to verifying that the designated compute node is authorized to receive the configuration data.

3. The method of claim 1, wherein the configuration profile identifier is wirelessly transmitted using a communication protocol selected from near-field communication, wireless local area network, and mobile personal area network.

4. The method of claim 1, wherein the configuration identifier includes a network location of the configuration data.

5. The method of claim 1, wherein the designated compute node receives the configuration identifier prior to boot up of the designated compute node.

6. The method of claim 1, wherein the designated compute node receives the configuration identifier prior to the designated compute node being connected to the network.

7. The method of claim 1, wherein the designated compute node is connected to a power source without being powered on when the designated compute node receives the configuration identifier.

8. The method of claim 7, wherein the designated compute node includes a service processor that receives the configuration identifier.

9. The method of claim 1, wherein the mobile communication device transmits the configuration profile identifier to the designated compute node using near-field communication.

10. The method of claim 9, wherein the mobile communication device and the designated compute node are paired for wireless communication in response to a physical tap between the mobile communication device and the designated compute node.

11. The method of claim 1, further comprising:
connecting the designated compute node to the network, wherein the designated compute node requests the configuration data associated with the configuration identifier in response to detecting that the designated compute node is connected to the network.

12. The method of claim 1, further comprising:
using a graphical interface on the mobile communication device to select the configuration that is to be assigned to the designated compute node.

13. The method of claim 12, further comprising:
using the graphical interface to input customized configuration details prior to transmitting the configuration identifier to the designated compute node, wherein the customized configuration details are wirelessly transmitted to the designated compute node along with the configuration identifier.

14. The method of claim 13, wherein the customized configuration details include a virtual network interface card address.

15. A method, comprising:
for each of a plurality of compute nodes within a network including a management node:
a mobile communication device assigning a configuration to the compute node by wirelessly transmitting a configuration identifier to the compute node; and
the compute node receiving the configuration identifier from the mobile communication device and providing the configuration identifier to the management node over the network;
the management node using the configuration identifier to identify configuration data uniquely associated with the configuration identifier;
the management node sending the identified configuration data to the compute node over the network; and
the compute node receiving the configuration data from the management node and applying the configuration data to achieve the assigned configuration.

16. The method of claim 15, further comprising:
the mobile communication device automatically incrementing one or more parameter of the configuration after assigning a configuration to each compute node, wherein the mobile communication device sequentially assigns a configuration to each compute node.

17. The method of claim 16, wherein each configuration includes a custom Internet protocol address, further comprising:
defining a starting Internet protocol address for a first configuration; and
automatically incrementing the Internet protocol address included in each successive configuration that is assigned to a compute node.

18. The method of claim 15, further comprising:
the mobile communication device storing a list of compute nodes that have been assigned a configuration, wherein the list identifies each compute node and the configuration that was assigned to each compute node.

19. The method of claim 18, further comprising:
the mobile communication device providing the list to the management node.

20. A computer program product comprising a non-transitory computer readable storage medium having program instructions embodied therewith, the program instructions executable by a processor to cause the processor to perform a method comprising:
a mobile communication device assigning a configuration to a designated compute node by wirelessly transmitting a configuration identifier to the designated compute node;
the designated compute node receiving the configuration identifier from the mobile communication device and providing the configuration identifier to a management node accessible over a network;
the management node using the configuration identifier to identify configuration data uniquely associated with the configuration identifier;
the management node sending the identified configuration data to the designated compute node over the network; and
the designated compute node receiving the configuration data from the management node and applying the configuration data to achieve the assigned configuration.
